(19) United States
(12) Patent Application Publication
(10) Pub. No.: US 2025/0059404 A1
(43) Pub. Date: Feb. 20, 2025

(54) SILICONE RELEASE ON NON-TOP COATED (NTC) DIRECT THERMAL (DT) PAPER FOR LINERLESS LABELS

(71) Applicant: Iconex LLC, Duluth, GA (US)

(72) Inventor: Jim Price, Morristown, TN (US)

(21) Appl. No.: 18/450,306

(22) Filed: Aug. 15, 2023

(51) Int. Cl. C09J 7/20

(52) U.S. Cl. CPC C09J 7/201; C09J 2203/334; C09J 2301/122; C09J 2301/208; C09J 2301/50

(57) ABSTRACT

A roll of linerless labels are manufactured from a non-top coated (NTC) substrate. A front side of the NTC substrate is coated with silicone and a backside of the NTC substrate is coated with adhesive. A web of the NTC substrate is wound into a roll. In an embodiment, the silicone is coated on top of a direct thermal (DT) coating disposed on the front side of the web of the NTC substrate.

### BACKGROUND

Labels are often made of top coated paper substrates. The substrates also include a variety of other coatings, such as direct thermal (DT) sensitive coatings, thermal transfer coatings, primer coatings, release coatings, adhesive coatings, etc. Linerless labels are made of a single substrate whereas linered labels include two or more substrates.

Typically, the substrate is manufactured with a top coating, so the substrate is sealed to restrict the amount of ink that is absorbed into the substrate allowing ink to sit on top of the paper without smearing or smudging. Non-top coated (NTC) substrates do not have a sealant coating and are therefore more porous such that ink soaks into the paper.

Linerless labels include a release coating applied to the front side of the substrate that allows an adhesive coating on the backside of the substrate to release from the front side and separate when the substrate is wound into a roll and subsequently unwound by a printer for custom imaging/printing. Often the release coating is a water-based coating. The problem with water-based release coatings is that they restrict how aggressive the adhesive can be for a linerless label because the more aggressive the adhesive is, the more difficult it is to unwind the roll within the printer, which means the roll is more likely to cause media jams within the printer. Another failure of using an aggressive adhesive with a water-based release coating is the adhesive pulls the release coating (and underlying coatings) off the surface of the substrate thus damaging the substrate.

Accordingly, water-based release coatings limit the selection of available aggressive adhesives, which are usable on the backside the linerless labels. Less aggressive adhesives limit the types of surfaces to which the label can be adhered (e.g., an aggressive adhesive is needed to stick to recycled product materials).

### SUMMARY

In various embodiments, linerless labels and rolls of linerless labels manufactured from a non-top coated (NTC) substrate with a silicone release coating are presented. In an embodiment, a method of manufacturing a roll of linerless is presented.

Specifically, and in an embodiment, a roll of linerless labels are manufactured from a NTC substrate. A front side of the NTC substrate is coated with silicone and a backside of the NTC substrate is coated with adhesive. A web of the NTC substrate is wound into a roll. In an embodiment, the silicone is coated on top of a direct thermal (DT) coating disposed on the front side of the web of the NTC substrate.

### BRIEF DESCRIPTION OF THE DRAWINGS

FIG. 1 is a diagram illustrating coatings on a direct thermal (DT) linerless label manufactured from a non-top coated (NTC) substrate, according to an example embodiment.

FIG. 2 is a diagram of a press configured to manufacture a DT linerless label from a NTC substrate, according to an example embodiment.

FIG. 3 is a diagram of a roll of DT linerless labels manufactured from a NTC substrate, according to an example embodiment.

FIG. 4 is a diagram of a method for manufacturing DT linerless labels from a NTC substrate, according to an example embodiment.

### DETAILED DESCRIPTION

Because non-top coated (NTC) paper is not pre-sealed with a topcoat, NTC paper is often less expense for purchase than is top coated paper. Optionally, the NTC paper includes a direct thermal (DT) coating provided by the substrate manufacturer. A DT coating does not exhibit the same characteristics or qualities as does top coated paper, such that even with a DT coating the paper is considered to be a NTC paper.

Top coatings are intended to seal the porous NTC paper and make the surface of the paper smoother whereas a DT coating provides a thermally activated or thermally sensitive coating, which when exposed to heat causes the surface of the paper to change colors or darken in the selective areas of the surface where heat was applied. DT printers include printheads that selectively supply the heat to the surface of the paper for purposes of providing custom indicia imaging/printing on the paper.

Thermal transfer coated paper supports transferring ink from a ribbon onto the surface of a top coated paper. A thermal print head of a printer applies heat to a ribbon and the ink is transferred from the ribbon on to the surface of the paper. The paper still requires a thermal transfer sensitive coating for the ink to be properly transferred onto the surface of the paper. Again, thermal transfer activated, or sensitive coatings are different from top coating sealants and do not have the same characteristics as topcoats.

As stated above, linerless labels typically are manufactured from top-coated paper, which seals and smooths the surface of the underlying substrate or paper. Top-coated papers are more expense than NTC papers. Moreover, often linerless labels utilize a water-based release coating on the front sides of the labels. Water-based release coatings do not provide sufficient separation from aggressive adhesives, which means that the linerless labels are forced to use less aggressive adhesives so that when a roll of the labels are unwound from a roll within a printer during imaging/printing the printer does not jam. As a result, linerless labels have limited applications that are based on the surfaces to which the labels are expected to be applied. For example, a less aggressive adhesive will not adhere or stick to recycled material surfaces.

These issues are solved with the linerless labels, rolls of the labels, and method of manufacturing the labels discussed herein. A linerless label is manufactured using a NTC substrate. The front side of a NTC includes a DT coating over which a silicone release coating is applied. The backside of the label is coated with any desired adhesive, including an aggressive adhesive. The coat weight for which the silicone release is applied over the DT coating can vary depending upon the type of substrate associated with the NTC substrate, such that the desired coat weight is a configurable processing parameter of a press that manufactures the linerless labels.

As used herein, an “aggressive adhesive” is an adhesive with 0.5 pounds per inch peel force and higher. A “non-aggressive adhesive is an adhesive” is an adhesive with under 0.5 pounds per inch peel force.

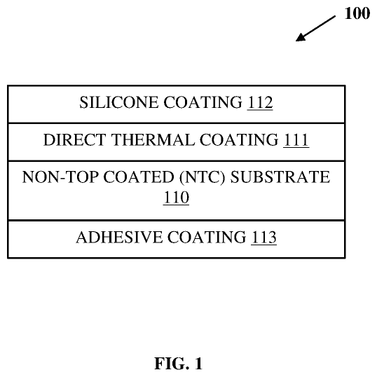

FIG. 1 is a diagram illustrating coatings on a direct thermal (DT) linerless label 100 manufactured from a non-top coated (NTC) substrate 110, according to an example embodiment. A front side or top side of the NTC substrate 110 includes an initial DT coating 111 over which a silicone release coating 112 is applied. The backside of the NTC substrate 110 includes an adhesive coating 113.

Conventionally, silicone coatings are not applied to NTC substrates; However, experimentation has revealed that a silicone release coating performs extraordinarily well with a wide variety of aggressive and non-aggressive adhesives. This means that the linerless label 100 can be wound into a roll and subsequently unwound by a printer without the substrate roll wrapping or causing the printer to jam when the printer is unable to unwind the roll even when the backside of the label includes an aggressive adhesive coating.

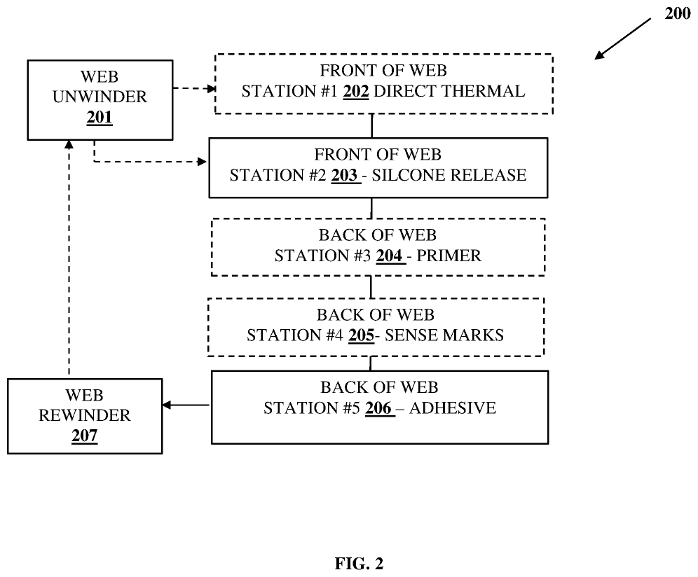

FIG. 2 is a diagram of a press 200 configured to manufacture a DT linerless label 100 from a NTC substrate 110, according to an example embodiment. The components of the press 200 are shown in simplified form with only those components necessary for understanding the teachings provided herein being illustrated. It is noted that the press can include more or less components than is illustrated without departing from the teachings presented herein.

Press 200 includes a web unwinder 201, stations 202-206, and a web unwinder 207. Station #1 202 is optional and provides components for applying an initial DT coating layer 111 to the front side of the NTC web substrate as the web is urged from station to station through the press 200. This is illustrated by the broken arrow from web unwinder 201 to station #1 202 in FIG. 2.

Station #2 203 provides components for applying the silicone release coating 112 over the DT coating 111 on the front side of the NTC web substrate. In an embodiment, the NTC web substrate includes an initial DT coating layer 111 on the front side of the NTC web substrate; in such case, the NTC web substrate is fed directly to station #2 as illustrated by the broken arrow from web unwinder 201 to station #2 203.

Station #3 204 is also optional and includes components for applying a primer coating on the backside of the NTC web substrate. Similarly, station #4 is optional and includes components for printing sense marks on the backside of the NTC web substrate. The sense marks delineate individual linerless labels 100 defined within the roll of the NTC web substrate. The printer reads the sense marks as instructions to the printer for imaging/printing a given linerless label 100 within the roll and for cutting and dispensing an imaged/printed linerless label 100 from the roll.

Station #5 includes components for applying an adhesive 113 coating on the backside of the NTC web substrate. The adhesives 113 can be selected from both aggressive adhesives and non-aggressive adhesives.

Notably, the NTC web substrate can be processed through the press 200 in a single pass or in multiple passes. More than a single pass is illustrated by the broken arrow from the web rewinder 207 back to the web unwinder 201. Multiple passes can be used for a variety of reasons; for example, to apply multiple different layers of adhesives 113 stacked atop one another.

Notably, each station (202, 203, 204, 205, and 206) can be configured to apply any of the coatings DT coating 111, silicone release coating 112, primer coating, and/or release coating 113. Thus, the number of stations associated with the press 200 is configurable. For example, the press 200 can include 2 stations for applying the silicone release coating 112 and the adhesive coating 113. Alternatively, the press 200 can include more than 2 stations but less than the 5 illustrated. Still further, the press 200 can include 6 or more stations.

Components of station #2 203 can be configured to apply a desired coat weight of the silicone release 112 to the front side of the NTC web substrate. In an embodiment, the silicone release coat weight is 1 gsm (grams per square meter), 2 gsm, 3 gsm, 4 gsm, or 5 gsm, or any fractional amount therein.

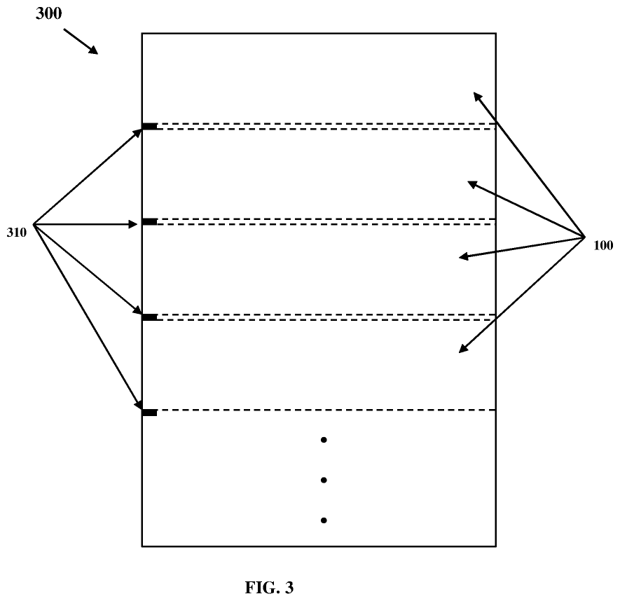

FIG. 3 is a diagram of a roll 300 of DT linerless labels 100 manufactured from a NTC substrate, according to an example embodiment. The roll 300 is illustrated in an unwound state for purposes of discussion; however, it is noted that once the roll 300 is manufactured by press 200 it is wound for distribution to customers and applications in their printers.

The roll 300 includes a plurality of individual linerless labels 100 defined within the NTC web substrate. The front side of the NTC web substrate is at least coated with a DT coating 111 and a silicone release coating 112 disposed over the DT coating 111. The backside of the NTC web substrate at least includes an adhesive coating 113 and includes printed sense marks 310. The sense marks 310 delineate and separate each linerless label within the roll 300.

The silicone coating 112 replaces any water-based release coating and serves as a release coating for the linerless labels 100 within the roll 300. That is, no additional release coatings are required once the silicone coating 113 is disposed on the front side of the NTC web substrate.

In an embodiment, the NTC web substrate does not original include the DT coating 111 and is added during manufacture by press 200. In an embodiment, the NTC web substrate includes a thermal transfer coating disposed under the silicone release coating 112 instead of the DT coating 111.

In an embodiment, the silicone release coating 112 is disposed on the front side of the NTC web substrate in a coat weight between 1 gsm and 5 gsm. In an embodiment, the coat weight of the silicone release coating 112 depends on a substrate type associated with the NTC web substrate.

In an embodiment, the adhesive coating 113 is an aggressive adhesive that exhibits sufficient tack to stick or to adhere to surfaces associated with recycled materials. In an embodiment, the coat weight of the silicone release coating 112 depends on a substrate type associated with the NTC web substrate. In an embodiment, the adhesive coating 113 is a non-aggressive adhesive that lacks sufficient tack to stick or to adhere to surfaces associated with recycled materials.

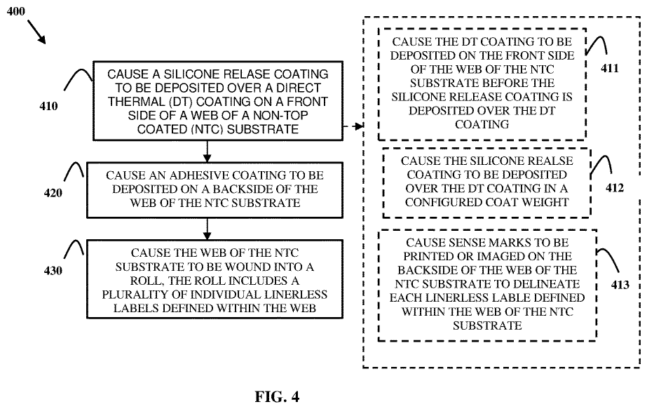

FIG. 4 is a diagram of a method 400 for manufacturing DT linerless labels 100 from a NTC substrate, according to an example embodiment. The method is implemented on a press 200 through firmware that controls electro-mechanical components of the press to manufacture a roll 300 of linerless labels 100. A processor associated with the firmware/software executes instructions to perform the method 400 and to control the electromechanical components of stations (202, 203, 204, 205, and/or 106) the press 200.

The press 200 at least includes stations 203 and 206, optionally the press includes one or more of stations 202, 204, and/or 205. Each station is associated with components for applying or depositing a given coating. In an embodiment, the coatings at least include a silicone release coating 112 and an adhesive coating 113. In an embodiment, the coatings include a DT coating 111, a release coating 112, and an adhesive coating 113.

The roll 300 includes a web of a NTC substrate. A web unwinder 201 of the press unwinds the roll 300 and passes the web through the stations of the press 200. Each roll 300 passed through the press 200 includes a plurality of instances of linerless labels 100 defined within the corresponding roll 300. The processor executes the instructions of the firmware/software to cause the corresponding electromechanical components of a given station 210 to add the corresponding specific coatings to the linerless labels 100 of the roll 300. The specific components added to the labels 100 at the stations include, by way of example only, at least three coatings, a DT coating 111 with a silicone release coating 112 atop the DT coating 111 on a front side of the web and an adhesive coating 113 on the backside of the web.

At 410, the processor of the press 200 causes a silicone release coating 112 to be deposited over a DT coating 111 on a front side of a web of a NTC substrate. In an embodiment, at 411, the processor of the press causes the DT coating 111 to be deposited on the front side of the web of the NTC substrate before the silicone release coating 112 is deposited over the DT coating 111.

In an embodiment, at 412, the processor of the press 200 causes the silicone release coating 112 to be deposited over the DT coating in a configured coat weight. In an embodiment, the configured coat weight can range between 1 gsm to 5 gsm.

In an embodiment, at 413, the processor of the press 200 causes sense marks to be printed or imaged on the backside of the web of the NTC substrate. The sense marks delineate and separate each linerless label from one another within the roll 300.

At 420, the processor of the press 200 causes an adhesive coating 113 to be deposited on a backside of a web of a NTC substrate. At 430, the processor of the press causes the web of the NTC substrate to be wound into a roll 300. The roll includes a plurality of individual linerless labels 100 defined within the web of the NTC substrate.

Although the present invention is described with reference to certain preferred embodiments thereof, variations and modifications of the present invention can be affected within the spirit and scope of the following claims.

1. A linerless label, comprising:
a non-top coated (NTC) substrate;
a silicone coating disposed on a front side of the NTC substrate; and
an adhesive coating disposed on a backside of the NTC substrate.

2. The linerless label of claim 1, wherein the front side includes a direct thermal coating disposed under the silicone coating.

3. The linerless label of claim 1, wherein the front side includes a thermal transfer thermal coating disposed under the silicone coating.

4. The linerless label of claim 1, wherein the silicone coating is disposed on the front side in a coat weight between 1 gsm (gram per square meter) and 5 gsm.

5. The linerless label of claim 1, wherein the adhesive coating is an aggressive adhesive or a non-aggressive adhesive.

6. The linerless label of claim 1, wherein the adhesive coating exhibits sufficient tack to stick or to adhere to surfaces associated with recycled materials.

7. The linerless label of claim 1, wherein a coat weight of the silicone coating depends on a substrate type associated with the NTC substrate.

8. The linerless label of claim 1, wherein the silicone coating is a release coating for the linerless label when linerless label is unwound from a roll of linerless labels within a printer.

9. A roll of linerless labels, comprising:
a web of a non-top coated (NTC) substrate;
a silicone coating disposed on a front side of the web of the NTC substrate; and
an adhesive coating disposed on a backside of the web of the NTC substrate;
wherein a plurality of linerless labels defined within the web of the NTC substrate.

10. The roll of linerless labels of claim 9 further comprising, sense marks printed or imaged on the backside of the web of the NTC substrate to delineate each of the labels within the web of the NTC substrate.

11. The roll of linerless labels of claim 9 further comprising, a direct thermal (DT) coating disposed under the silicone coating on the front side of the web of the NTC substrate.

12. The roll of linerless labels of claim 9, wherein a coat weight of the silicone coating is between 1 gsm (grams per square meter) and 5 gsm.

13. A roll of linerless labels, comprising:
a substrate; and
a first layer of an adhesive deposited on a backside of the substrate;
a second layer of the adhesive deposited over the first layer of adhesive; and
a third layer of the adhesive deposited over the second layer of adhesive.

14. The roll of linerless labels of claim 13 further comprising:
one or more additional layers of the adhesive, each additional layer of the adhesive deposited over a previous deposited layer of the adhesive.

15. The roll of linerless labels of claim 13, wherein.

16. The roll of linerless labels of claim 13, wherein.

17. A method, comprising:
causing a silicone release coating to be deposited over a direct thermal (DT) coating on a front side of a web of a non-top coated (NTC) substrate;
causing an adhesive coating to be deposited on a backside of the web of the NTC substrate; and
causing the web of the NTC substrate to be wound into a roll, wherein the roll includes a plurality of individual linerless labels defined within the web of the NTC substrate.

18. The method of claim 17, wherein causing the silicone release coating to be deposited over the DT coating further includes causing the DT coating to be deposited on the front side of the web of the NTC substrate before the silicone release coating is deposited over the DT coating.

19. The method of claim 17, wherein causing the silicone release coating to be deposited over the DT coating further includes causing the silicone release coating to be deposited over the DT coating in a configured coat weight.

20. The method of claim 17, wherein causing the silicone release coating to be deposited over the DT coating further includes causing sense marks to be printed or imaged on the backside of the web of the NTC substrate to delineate each linerless label defined within the web of the NTC substrate.
